(19) United States
(12) Patent Application Publication
(10) Pub. No.: US 2006/0092573 A1
(43) Pub. Date: May 4, 2006

(54) Latch system of hard disk drive and method of forming the latch system

(75) Inventors: Jeong-il Chun, Seongnam-si (KR); Yong-kyu Byun, Yongin-si (KR); Min-pyo Hong, Suwon-si (KR); Dong-ho Oh, Seoul (KR); Byoung-gyou Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/174,596

(22) Filed: Jul. 6, 2005

(30) Foreign Application Priority Data
Nov. 3, 2004 (KR) 10-2004-0088860

(51) Int. Cl. G11B 21/22; G11B 5/54

(52) U.S. Cl. 360/256.4

(57) ABSTRACT

A latch system for a hard disk drive and a method of forming the latch system are disclosed. The latch system includes an actuator on which a read/write head is installed, and a latch locking the actuator. The actuator and the latch each has a mass center and a pivot center, and a direction of the mass center of the latch on the basis of the pivot center of the latch is the same as a direction of the mass center of the actuator on the basis of the pivot center of the actuator.

### BACKGROUND OF THE INVENTION

This application claims priority from Korean Patent Application No. 10-2004-0088860, filed on Nov. 3, 2004, in the Korean Intellectual Property Office, the disclosure of which is incorporated herein in its entirety by reference.

1. Field of the Invention

The present invention relates to a latch system of a hard disk drive (HDD) and a method of forming the latch system, and more particularly, to a latch system of an HDD that considers mass imbalance and a method of forming the latch system that considers mass imbalance.

2. Description of the Related Art

Hard disk drives (HDDs), which store information in computers, reproduce data stored in a disk or record data on the disk using a read/write head.

A conventional HDD comprises an actuator having a front end on which a read/write head is installed, and a latch locking the actuator. Due to an error caused while processing or assembling parts, a mass center and a pivot center of the actuator do not coincide with each other and a mass center and a pivot center of the latch do not coincide with each other. The non-coincidence between the mass center and the pivot center of the actuator and the latch may cause the latch to fail to lock the actuator when a shock load is applied to the HDD, for example, due to dropping during transport. This non-coincidence may result in a scratch on the disk and/or damage to the head. In particular, this problem may be serious for a HDD that is disposed in a mobile device, e.g., a laptop computer or a music device.

FIG. 1 is a plan view of a conventional HDD illustrating a mass center and a pivot center for both of a latch and an actuator. FIG. 2 is a plan view illustrating a state where an external shock is applied to one side of the conventional HDD shown in FIG. 1. FIG. 3 is a plan view illustrating a state where an external shock is applied to the other side of the conventional HDD shown in FIG. 1.

Referring to FIGS. 1 through 3, a conventional hard disk drive 1 comprises a magnetic disk 2 rotated by a spindle motor 3, and an actuator 10 comprising a front end on which a read/write head 12 is installed. The spindle motor 3 may be mounted on a base member 4 of the HDD 1.

The actuator 10 is pivotably installed on the base member 4, and the head 12 performs read/write operations according to the pivoting of the actuator 10. A voice coil motor (VCM) 11 installed at a rear end of the actuator 10 causes the actuator 10 to pivot. If the VCM 11 is turned on, a torque for rotating the actuator 10 is generated. The head 12 traverses a surface of the disk 2 due to the generated torque to perform read/write operations.

The HDD 1 comprises a latch 20 formed on a notch part 13 that is disposed at the rear end of the actuator 10. The latch 20 is caught in the notch part 13 to lock the actuator 10 when the actuator 10 unexpectedly moves due to an external shock or a similar event.

In FIGS. 1 through 3, reference numeral 14 denotes a pivot center of the actuator 10, reference numeral 15 denotes a mass center of the actuator 10, reference numeral 21 denotes a pivot center of the latch 20, and reference numeral 22 denotes a mass center of the latch 20. The pivot center 14 and the mass center 15 of the actuator 10 do not coincide with each other, and the pivot center 21 and the mass center 22 of the latch 20 do not coincide with each other. The non-coincidence may be produced by an error caused while processing and assembling the actuator 10 and the latch 20.

In a conventional HDD, a direction of the mass center 15 of the actuator 10 on the basis of the pivot center 14 of the actuator 10 is different from a direction of the mass center 22 of the latch 22 on the basis of the pivot center 21 of the latch 20. In this arrangement, if an external shock is applied to the HDD 1, the latch 20 may fail to lock the actuator 10, depending on a direction in which the external shock is applied. In detail, as shown in FIG. 2, if an external shock is applied to one side of the HDD 1, the actuator 10 and the latch 20 rotate in opposite directions to engage with each other, thereby making the actuator 10 locked. In contrast, as shown in FIG. 3, if an external shock is applied to the other side of the HDD 1, the actuator 10 and the latch 20 rotate in opposite directions not to engage with each other, thereby leaving the actuator 10 unlocked.

However, the unlocking of the actuator due to the non-coincidence between the mass center and the pivot center of both the actuator and the latch has rarely been studied. Accordingly, there is a demand for a system that can prevent the actuator from being unlocked.

### SUMMARY OF THE INVENTION

The present invention provides a latch system of a hard disk drive, which can reliably lock an actuator using a latch by adjusting a mass center and a pivot center for both of the actuator and the latch, and a method of forming the latch system having adjusted mass centers and pivot centers.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

According to an aspect of the present invention, there is provided a latch system of a hard disk drive, the latch system comprising an actuator on which a read/write head is installed, and a latch locking the actuator. The actuator and the latch each has a mass center and a pivot center, and a direction of the mass center of the latch on the basis of the pivot center of the latch is the same as a direction of the mass center of the actuator on the basis of the pivot center of the actuator.

According to another aspect of the present invention, there is provided a latch system of a hard disk drive, the latch system comprising an actuator comprising a read/write head, and a latch locking the actuator. The actuator and the latch each has a mass center and a pivot center, and a quarter in which the mass center of the latch is included among four equal parts drawn on the basis of the pivot center of the latch is the same as a quarter in which the mass center of the actuator is included among four equal parts drawn on the basis of the pivot center of the actuator.

According to another aspect of the present invention, there is provided a method of forming a latch system of a hard disk drive comprising an actuator and a latch, each having a pivot center and a mass center. The method comprises grasping the mass center of the actuator, and adjusting the mass center of the latch in association with the mass center of the actuator. The grasping of the mass center of the actuator comprises obtaining a direction of the mass center of the actuator on the basis of the pivot center of the actuator. The adjustment of the mass center of the latch comprises adjusting a direction of the mass center of the latch with respect to the direction of the mass center of the actuator.

The adjusting of the direction of the mass center of the latch comprises adjusting the direction of the mass center of the latch on the basis of the pivot center of the latch to be the same as the direction of the mass center of the actuator on the basis of the pivot center of the actuator. Alternatively, the adjusting of the direction of the mass center of the latch comprises adjusting a quarter in which the mass center of the latch is included among four equal parts drawn on the basis of the pivot center of the latch to be the same as a quarter in which the mass center of the actuator is included among four equal parts drawn on the basis of the pivot center of the actuator.

Additional aspects and/or advantages of the invention will be set forth in part in the description which follows and, in part, will be apparent from the description, or may be learned by practice of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of a conventional hard disk drive (HDD) illustrating a mass center and a pivot center of a latch and of an actuator;

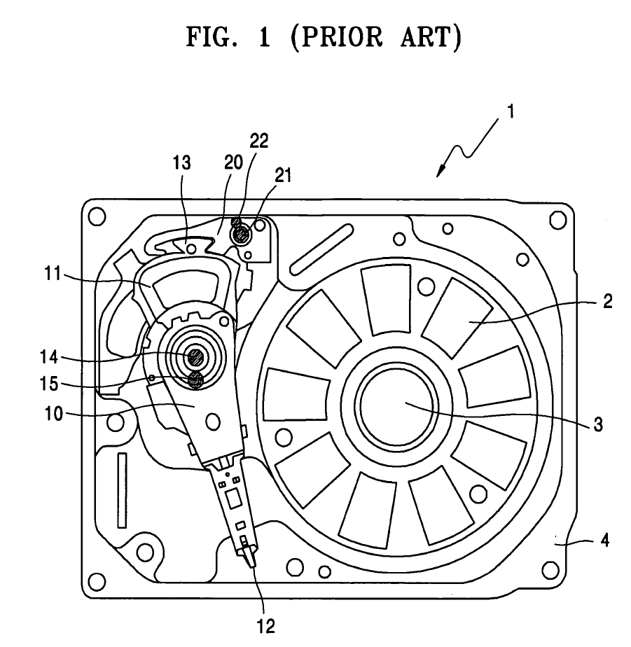

FIG. 2 is a plan view of the conventional HDD shown in FIG. 1 illustrating a state where an external shock is applied to one side of the conventional HDD;

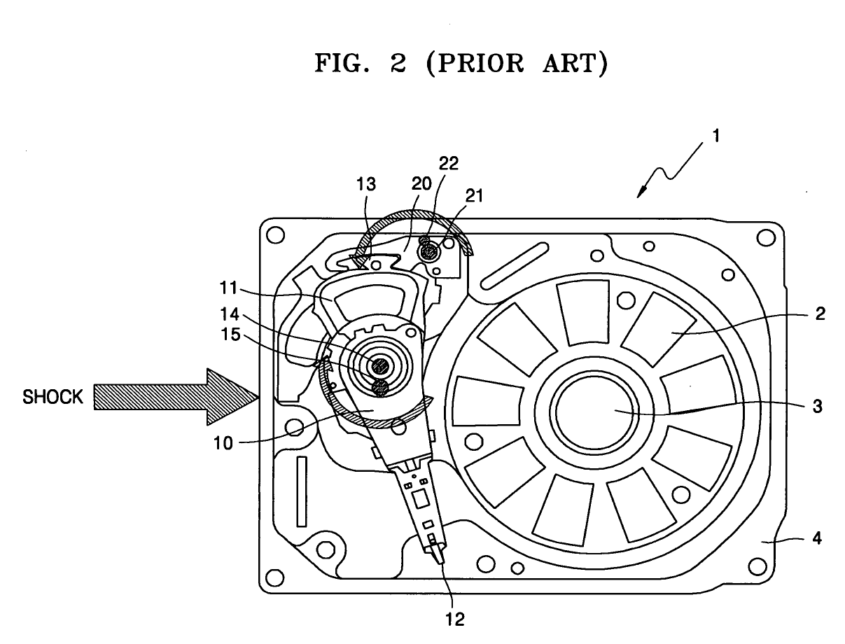

FIG. 3 is a plan view of the conventional HDD shown in FIG. 1 illustrating a state where an external shock is applied to the other side of the conventional HDD;

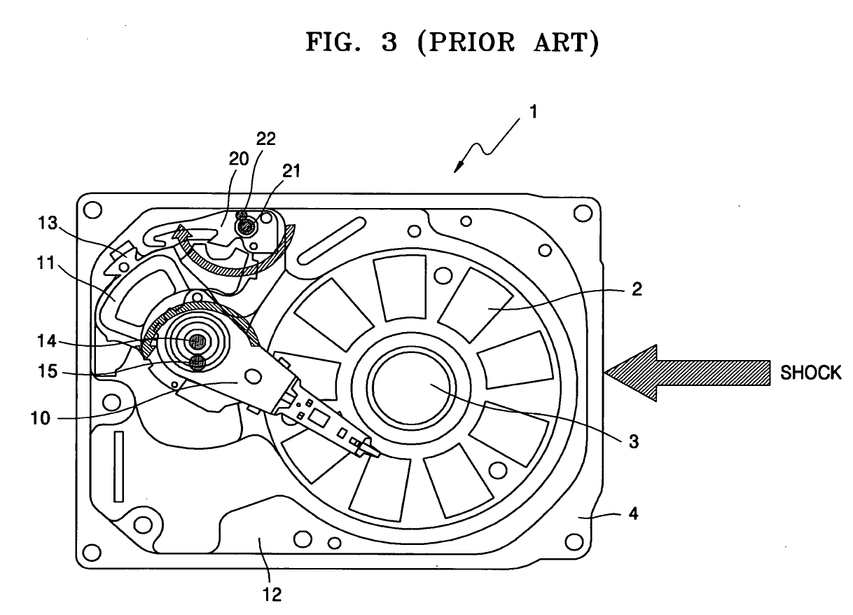

FIG. 4 is a plan view of an HDD with a latch system consistent with an exemplary an embodiment of the present invention illustrating a mass center and a pivot center for both of a latch and an actuator of the latch system;

FIG. 5 is a plan view of the HDD with the latch system shown in FIG. 4 illustrating a state wherein an external shock is applied to one side of the HDD;

FIG. 6 is a plan view of the HDD with the latch system shown in FIG. 4 illustrating a state where an external shock is applied to the other side of the HDD;

FIG. 7 is a plan view of an HDD with a latch system consistent with an exemplary embodiment of the present invention illustrating a mass center and a pivot center for both of a latch and an actuator of the latch system;

FIG. 8 is a plan view of the HDD with the latch system shown in FIG. 7 illustrating a state where an external shock is diagonally applied to one side of the HDD; and

FIG. 9 is a plan view of the HDD with the latch system shown in FIG. 7 illustrating a state where an external shock is diagonally applied to the other side of the HDD.

### DETAILED DESCRIPTION OF THE ILLUSTRATIVE, NON-LIMITING EMBODIMENTS OF THE INVENTION

The present invention will now be described more fully with reference to the accompanying drawings, in which an illustrative, non-limiting embodiments of the invention are shown. The same elements are given the same reference numerals.

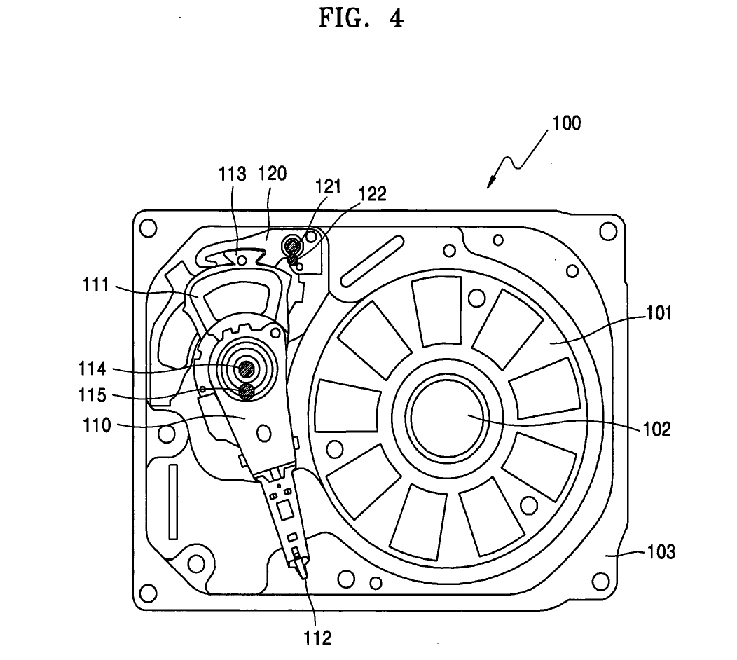

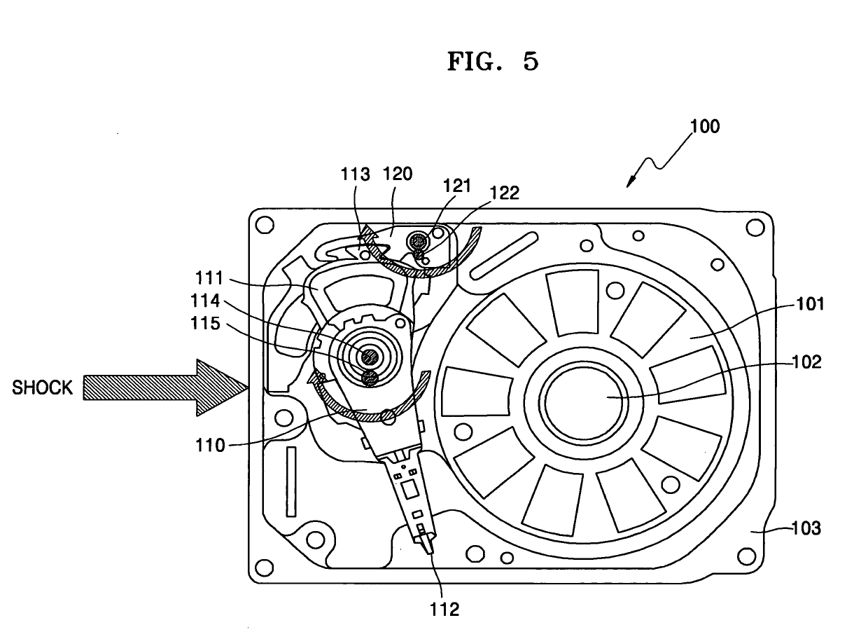

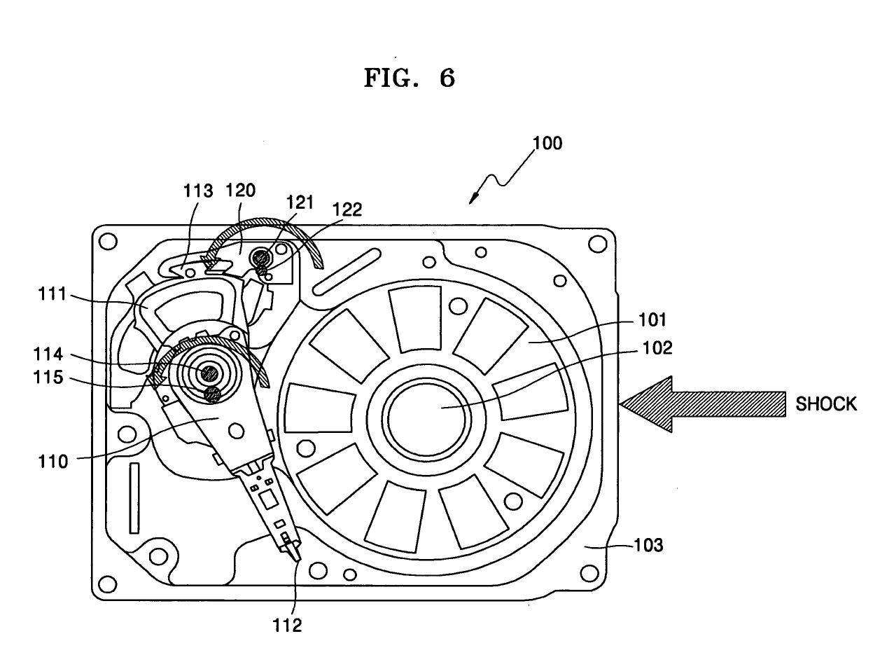

FIG. 4 is a plan view of a hard disk drive (HDD) with a latch system according to an embodiment of the present invention illustrating a mass center and a pivot center for both of a latch and an actuator of the latch system. FIG. 5 is a plan view of the HDD with the latch system shown in FIG. 4 illustrating a state where an external shock is applied to one side of the HDD. FIG. 6 is a plan view of the HDD with the latch system shown in FIG. 4 illustrating a state where an external shock is applied to the other side of the HDD.

Referring to FIGS. 4 through 6, an HDD 100 comprises a magnetic disk 101 rotated by a spindle motor 102, and an actuator 110 comprising a front end on which a read/write head 112 is installed. The spindle motor 102 may be mounted on a base member 103 of the HDD 100.

The actuator 110 is pivotably installed on the base member 103, and the head 112 performs read/write operations according to the pivoting of the actuator 110. A voice coil motor (VCM) 111 installed at a rear end of the actuator 110 causes the actuator 110 to pivot. If the VCM 111 is turned on, a torque for rotating the actuator 110 is generated. Due to the generated torque, the head 112 traverses a surface of the disk 101 to perform read/write operations.

The HDD 100 comprises a latch 120 formed on a notch part 113 that is disposed at the rear end of the actuator 110. The latch 120 is caught in the notch part 113 to lock the actuator 110 when the actuator 110 unexpectedly pivots due to an external shock or the like.

In FIGS. 4 through 6, reference numeral 114 denotes a pivot center of the actuator 110, reference numeral 115 denotes a mass center of the actuator 110, reference numeral 121 denotes a pivot center of the latch 120, and reference numeral 122 denotes a mass center of the latch 120. In the exemplary embodiment, a direction of the mass center 115 of the actuator 110 on the basis of the pivot center 114 of the actuator 110 is the same as a direction of the mass center 122 of the latch 120 on the basis of the pivot center 121 of the latch 120. In this arrangement, if an external shock is applied to the HDD 100, the latch 120 can smoothly lock the actuator 110 irrespective of a direction in which the shock is applied. In detail, as shown in FIG. 5, if an external shock is applied to one side of the HDD 100, the actuator 110 and the latch 120 rotate in the same direction to engage with each other, thereby making the actuator 110 locked. Also, as shown in FIG. 6, if an external shock is applied to the other side of the HDD 100, the actuator 110 and the latch 120 rotate in the same direction to engage with each other, thereby making the actuator 110 locked. Accordingly, it is preferable that the mass centers 115 and 122 of the actuator 110 and the latch 120 be formed in the same direction respectively on the basis of the pivot centers 114 and 121 of the actuator 110 and the latch 120, so as for the latch 120 to smoothly lock the actuator 110.

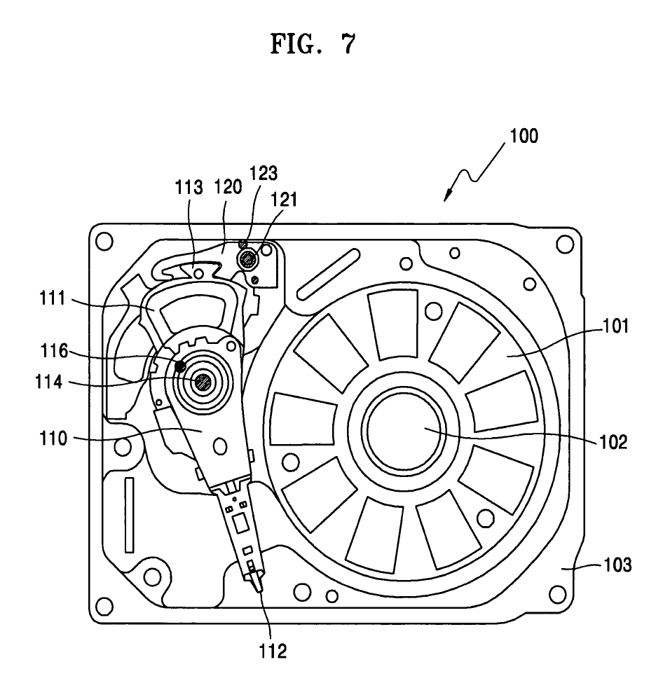

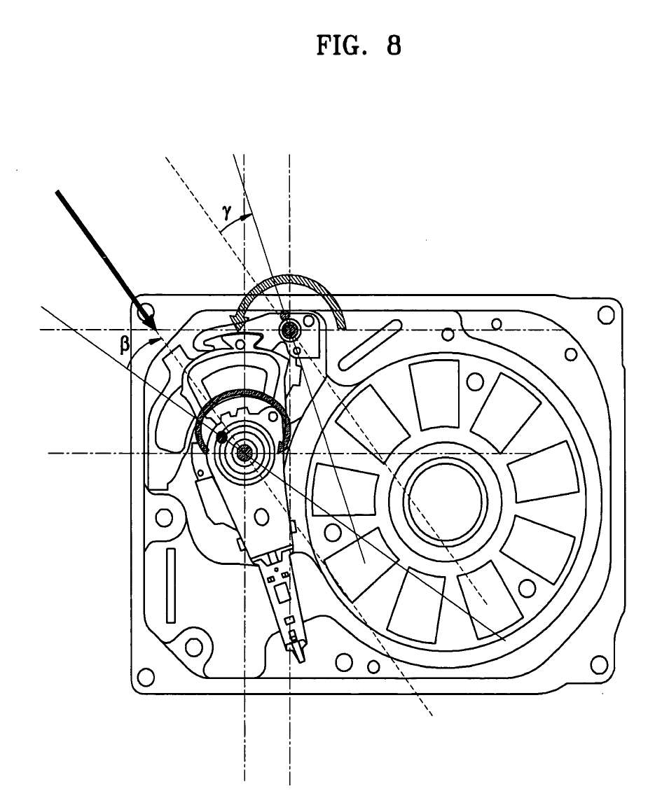

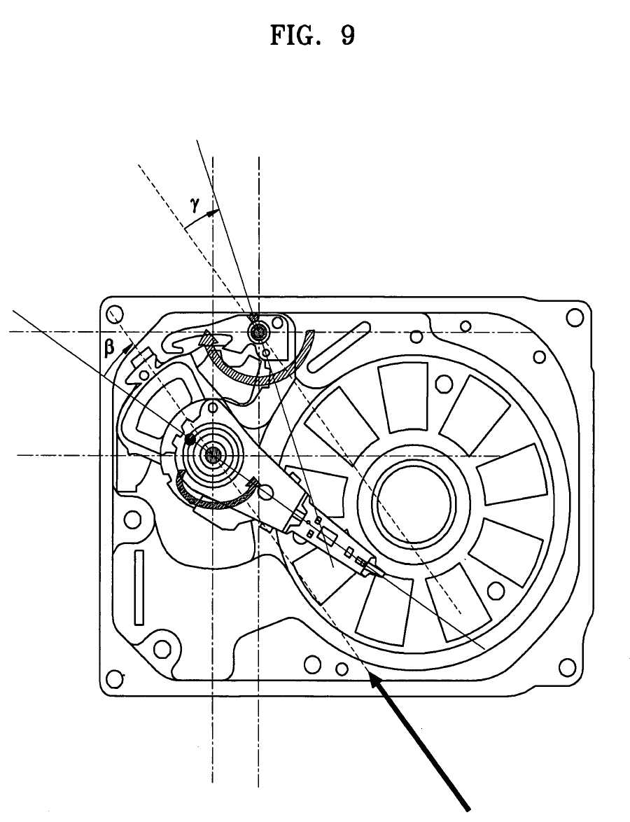

FIG. 7 is a plan view of an HDD with a latch system according to another exemplary embodiment of the present invention illustrating a mass center and a pivot center for both of a latch and an actuator of the latch system. FIG. 8 is a plan view of the HDD with the latch system shown in FIG. 7 illustrating a state where an external shock is diagonally applied to one side of the HDD. FIG. 9 is a plan view of the HDD with the latch system shown in FIG. 7 illustrating a state where an external shock is diagonally applied to the other side of the HDD.

Referring to FIGS. 7 through 9, reference numeral 114 denotes a pivot center of the actuator 110, reference numeral 116 denotes a mass center of the actuator 110, reference numeral 121 denotes a pivot center of the latch 120, and reference numeral 123 denotes a mass center of the latch 120. In the exemplary embodiment, a quarter in which the mass center 116 of the actuator 110 is included among four equal parts drawn on the basis of the pivot center 114 of the actuator 110 is the same as a quarter in which the mass center 123 of the latch 120 is included among four equal parts drawn on the basis of the pivot center 121 of the latch 120.

In this arrangement, if an external shock is applied to the HDD 100, the actuator 110 is locked by the latch 120, or a torque generated by the applied shock is reduced to prevent the actuator 110 from pivoting beyond a predetermined angle. In detail, as shown in FIG. 8, if an external shock is diagonally applied to one side of the HDD 100, the actuator 110 and the latch 120 rotate in opposite directions to engage with each other, thereby making the actuator 110 locked. In contrast, as shown in FIG. 9, if an external shock is diagonally applied to the other side of the HDD 100, the actuator 110 and the latch 120 rotate in opposite directions, not to engage with each other, leading to a risk that the actuator 110 may pivot beyond the predetermined angle. In the exemplary embodiment, the mass centers 116 and 123 of the actuator 110 and the latch 120 are formed in the same quarter among the four equal parts respectively drawn on the basis of the pivot centers 114 and 121, and are distributed left and right with respect to the external shock. In FIG. 9, a torque generated in the actuator 110 due to the external shock is proportional to a force obtained by multiplying the external shock by the sine of β. Also, in FIG. 9, a torque generated in the latch 120 due to the external shock is proportional to a force obtained by multiplying the external shock by the sine of γ. Here, β denotes an angle between a direction of the external shock and a direction of the mass center 116 of the actuator 110 on the basis of the pivot center 114 of the actuator 110, and γ denotes an angle between a direction of the external shock and a direction of the mass center 123 of the latch 120 on the basis of the pivot center 121 of the latch 120. Accordingly, since the torques generated in the actuator 110 and the latch 120 due to the external shock are respectively proportional to the sine of β and and the sine of γ, the values of β and γ should be reduced to reduce the torques. Thus, it is preferable that the mass center 116 of the actuator 110 and the mass center 123 of the latch 120 be formed in the same quarter.

A method of forming a latch system of an HDD according to an exemplary embodiment of the present invention will be explained with reference to FIGS. 4 and 9.

First, the mass center 115 or 116 of the actuator 110 is grasped. The mass center 115 or 116 of the actuator 110 is obtained on the basis of the pivot center 114 of the actuator 110.

Thereafter, a direction of the mass center 122 or 123 of the latch 120 is adjusted on the basis of the pivot center 121 of the latch 120 with respect to a direction of the mass center 115 or 116 of the actuator 110. As shown in FIG. 4, so as for the latch 120 to smoothly lock the actuator 110, the direction of the mass center 122 of the latch 120 can be adjusted to be the same as the direction of the mass center 115 of the actuator 110. Alternatively, as shown in FIG. 7, so as to reduce torques generated in the latch 120 and the actuator 110 due to an external shock, a quarter in which the mass center 123 of the latch 120 is included among four equal parts drawn on the basis of the pivot center 121 of the latch 120 can be adjusted to be the same as a quarter in which the mass center 116 of the actuator 110 is included among four equal parts drawn on the basis of the pivot center 114 of the actuator 110.

According to the latch system of the HDD and the method of forming the latch system, the latch can smoothly lock the actuator by adjusting the mass center of the latch with respect to the mass center of the actuator.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A latch system of a hard disk drive, the latch system comprising:
an actuator comprising a read/write head; and
a latch locking the actuator,
wherein the actuator and the latch each has a mass center and a pivot center, and a direction of the mass center of the latch on the basis of the pivot center of the latch is the same as a direction of the mass center of the actuator on the basis of the pivot center of the actuator.

2. A latch system of a hard disk drive, the latch system comprising:
an actuator comprising a read/write head; and
a latch locking the actuator,
wherein the actuator and the latch each has a mass center and a pivot center, and a quarter in which the mass center of the latch is included among four equal parts drawn on the basis of the pivot center of the latch is the same as a quarter in which the mass center of the actuator is included among four equal parts drawn on the basis of the pivot center of the actuator.

3. A method of forming a latch system of a hard disk drive comprising an actuator and a latch, each having a pivot center and a mass center, the method comprising:
grasping the mass center of the actuator; and
adjusting the mass center of the latch in association with the mass center of the actuator.

4. The method of claim 3, wherein the grasping of the mass center of the actuator comprises obtaining a direction of the mass center of the actuator on the basis of the pivot center of the actuator.

5. The method of claim 3, wherein the adjusting of the mass center of the latch comprises adjusting a direction of the mass center of the latch with respect to the direction of the mass center of the actuator.

6. The method of claim 5, wherein the adjusting of the direction of the mass center of the latch comprises adjusting the direction of the mass center of the latch on the basis of the pivot center of the latch to be the same as the direction of the mass center of the actuator on the basis of the pivot center of the actuator.

7. The method of claim 5, wherein the adjusting of the direction of the mass center of the latch comprises adjusting a quarter in which the mass center of the latch is included among four equal parts drawn on the basis of the pivot center of the latch to be the same as a quarter in which the mass center of the actuator is included among four equal parts drawn on the basis of the pivot center of the actuator.
